(19) United States
(12) Patent Application Publication
(10) Pub. No.: US 2023/0154446 A1
(43) Pub. Date: May 18, 2023

(54) AI Tool to Improve Music Performance

(71) Applicant: Douglas Wyeth Herz, Pleasanton, CA (US)

(72) Inventor: Douglas Wyeth Herz, Pleasanton, CA (US)

(21) Appl. No.: 18/097,140

(22) Filed: Jan. 13, 2023

Related U.S. Application Data
(60) Provisional application No. 63/299,332, filed on Jan. 13, 2022.

(51) Int. Cl. G10H 1/00

(52) U.S. Cl. CPC G10H 1/0008; G10H 2210/091; G10H 2210/071; G10H 2210/066

(57) ABSTRACT

Disclosed embodiments include systems and methods to teach and analyze a student's progress in learning to play a musical instrument, sing or perform other musical endeavors. Embodiments include the production of an AI score or music AI score which may be an extraction of performance parameters such as a student's tone, speed, rhythm, pitch loudness and other metrics. A musical AI score may also track changes in measured performance while playing a piece of music. Such changes within a piece of music or over time in performing various pieces of music can be valuable is a student's self-assessment or a music teacher's approach tailored to the particular student. A music or signing AI score can help a student to select and to prioritize their music repertoire, focus performance efforts, optimize time schedule, improve appreciation for music, improve the overall quality of music performance and instructor relationship.

### RELATED PATENT APPLICATION AND INCORPORATION BY REFERENCE

This is a utility application based upon U.S. patent application Ser. No. 63/299,332 filed on Jan. 13, 2022. This related application is incorporated herein by reference and made a part of this application. If any conflict arises between the disclosure of the invention in this utility application and that in the related provisional application, the disclosure in this utility application shall govern. Moreover, the inventor incorporates herein by reference any and all patents, patent applications, and other documents hard copy or electronic, cited or referred to in this application.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

Learning is most efficient when a student can compare himself or herself with an exact standard. In mathematics, for example, students can compare their answers with an answer key. In music, however, the student must rely upon the subjectivity of an instructor to determine whether they are playing correctly (too loud or too soft; too fast or too slow; too sharp or too flat, etc.). The disclosed embodiments presented herein overcome the subjectivity of the instructor by adding AI technology as a totally objective evaluator of the student's performance. This performance may be immediately compared directly with the composer's score in multiple dimensions and a series of Expert System recommendations are created to improve the performance, so both student and instructor benefit.

The disclosed embodiments include systems well suited for evaluation and teaching in the playing of musical instruments, singing and other musical endeavors.

### PRIOR ART

Various musical notation or reporting system are known in the prior art, but such systems fail to disclose or anticipate the embodiments presented herein. The known prior art includes:

U.S. Pat. No. 9,390,690 by Daniels issued on Jul. 12, 2016; U.S. Pat. No. 9,812,029 by Henry issued on 9,812,029; U.S. Pat. No. 9,905,207 by Louhivuori et al issued on Feb. 27, 2018 and US published patent application 2018/0137770 by Whisenant published on May 17, 2018.

(1) Field of the Invention is Artificial Intelligence Expert Systems

The disclosed embodiments generally relates to improving the instruction of music. More particularly, the disclosed embodiments relate to the use of an Artificial Intelligence Expert System to help music students focus and accelerate their music performance. The system also provides sight reading students with immediate feedback for a more rapid and accurate learning experience.

This technology presents several unobvious improvements to the related art in several areas and/or uses components of the related art in novel and unobvious ways:

(1) The prior art includes Virtual Studio Technology (VST) software is used for audio analysis as shown in FIG. 1 The functions of VSTs include spectrum analyzers using the Fast Fourier Transform (FFT) to display signal frequency in real time, and statistics such as RMS power and clipping. Examples are Voxengo SPAN, BlueCat FreqAnalyst, and ag-works Sonogram SG-1.

(2) Sheet music scanners will scan sheet music and play back from any part of the song, with any instrument. Examples include scanscore and NotateMe. See FIG. 2 for a music scanner example.

Disclosed embodiments may comprise a Dynamic Sheet Music Library, a sheet music scanner to calculate musical parameters of the Sheet Music, a VST to calculate musical parameters from an audio recording of the student, with a Parameter Comparison Engine to determine the resulting equivalences and differences, note-by-note and parameter-by-parameter, between the Sheet Music and the student recording. See FIG. 3 for an example of the output from the Parameter Comparison Engine. Final components of the disclosed embodiments may include Expert System Guidance outlining how the student can further improve, and Storage and Security for all the components. Finally, a UI/UX (User Interface/User Experience) module including targeted Social Media and Instruction Syllabus generates Output that the student and instructor can access on the device(s) of their choosing.

The disclosed embodiments overcome shortfalls in the related art by offering a paradigm shift in AI, computer components and databases, systems and methodologies towards teaching sound music fundamentals from objective data derived by the disclosed embodiments. Whereas VSTs and sheet music scans have been used individually for many years, the use of them in the disclosed combinations is new and not an obvious combination of prior art. The Parameter Difference Flags or markings are new. The use of Expert Systems, Social Media, FAQs, Teaching Syllabi, Blog, and Knowledge Base in this context is also new. The results can be used to grade students, select orchestra members, conduct competitions, bestow awards, compare instruments, and select members of musical societies. Disclosed embodiments may help teachers help students as the teachers see a variety of performance metrics.

The known related art fails to disclose, suggest or teach the use of the disclosed Artificial Intelligence systems.

There is a unique opportunity to leverage the work herein described for a social media effort aimed at comparisons with averages, daily training goals, teams, awards, group activities, mutual information sharing and writing blog articles. The disclosed embodiments facilitate a student's selection of a teacher, sharing the music learning experience on social media and enjoying and adding comments upon social media.

### BRIEF DESCRIPTION OF THE DRAWINGS

FIG. 1 is an example of Prior Art, Virtual Studio Technology (VST)

FIG. 2 is an example of a Prior Art Sheet Music Scanner

FIG. 3 is an example output from the Parameter Comparison Engine, showing the Parameter Difference Flags by use of black and white symbols.

FIG. 4 is a block diagram of a disclosed AI Tool

### REFERENCE NUMBERS

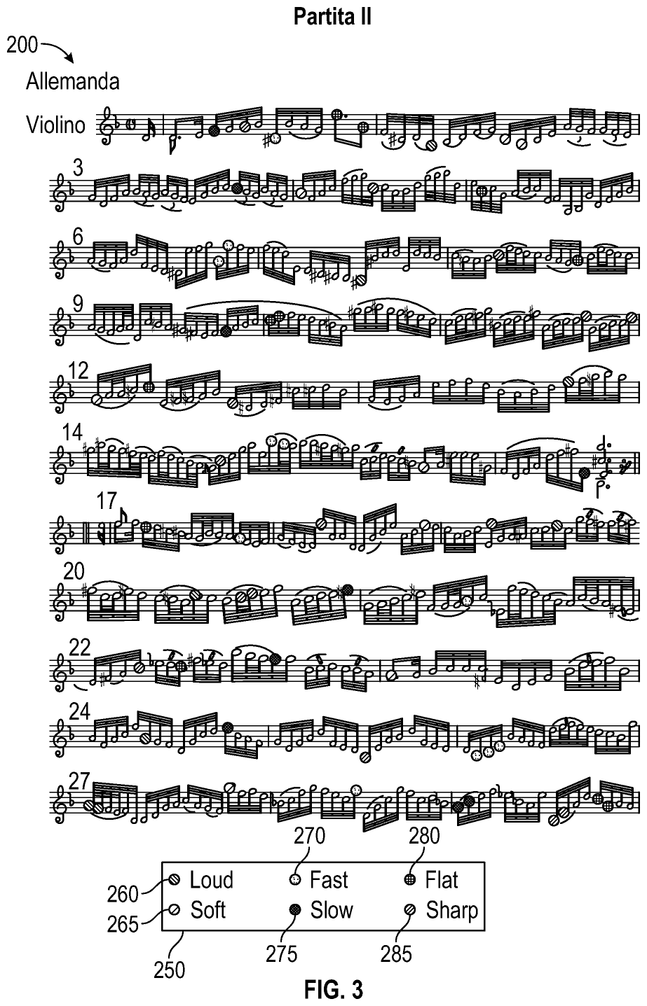

100 prior art of Scan Score
200 sheet music in digital format, analog or printed format comparing a student's performance of music with the intended performance of the music
250 a table of symbols
260 a symbol showing music to have been played too loud
265 a symbol showing music to have been played too soft
270 a symbol showing music to have been played too fast
275 a symbol showing music to have been played too slow
280 a symbol showing music to have been played flat
285 a symbol showing music to have been played sharp
300 a system to create a comparison of how music is played as compared to the intended performance as predefined by written music or sheet music
310 extracted parameters or table of extracted parameters
312 an extracted parameter of completeness
313 an extracted parameter of tone
314 an extracted parameter of rhythm
315 an extracted parameter of volume
316 an extracted parameter of other attributes
322 dynamic sheet music library
325 decision criteria teaching syllabus module
327 student music repertoire module
329 selected sheet music module
331 parameter extraction module, or sheet music extraton module, extracting data or parameters from the sheet music, sometimes executed by use of a sheet music scanner
333 selected piece of student music to be played or sung by the student
335 audio input device, may digitize music or singing by a student
337 parameter extraction from music or singing of a student.
340 parameter comparison engine, may be used to create an output such as the performance chart of FIG. 3
350 parameter difference module
360 social media module
362 multi-device UI/UX system or interface
365 teaching syllabus module

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

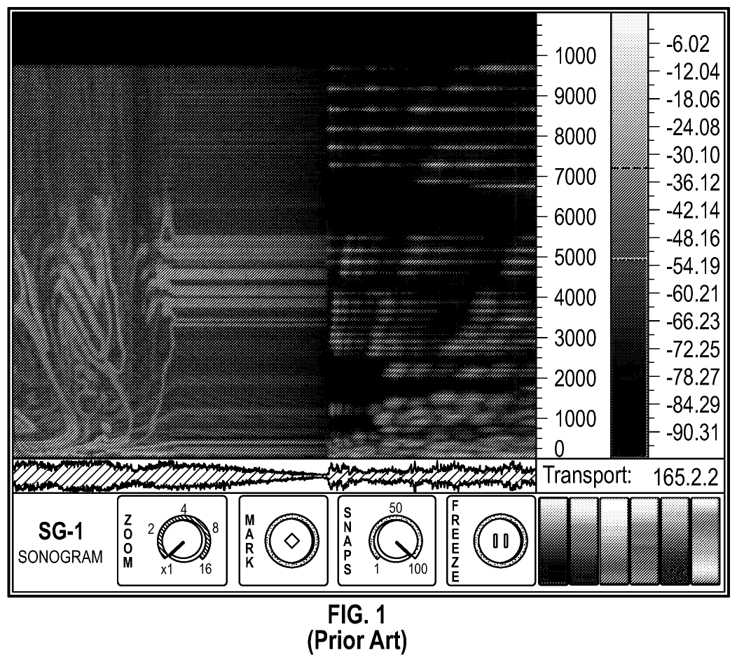

Referring to FIG. 1, this is a commercially available Prior Art product and shown for illustrative purposes only. Virtual Studio Technology (VST) shows music parameters but fails to suggest means or methods of teaching the playing of music or singing.

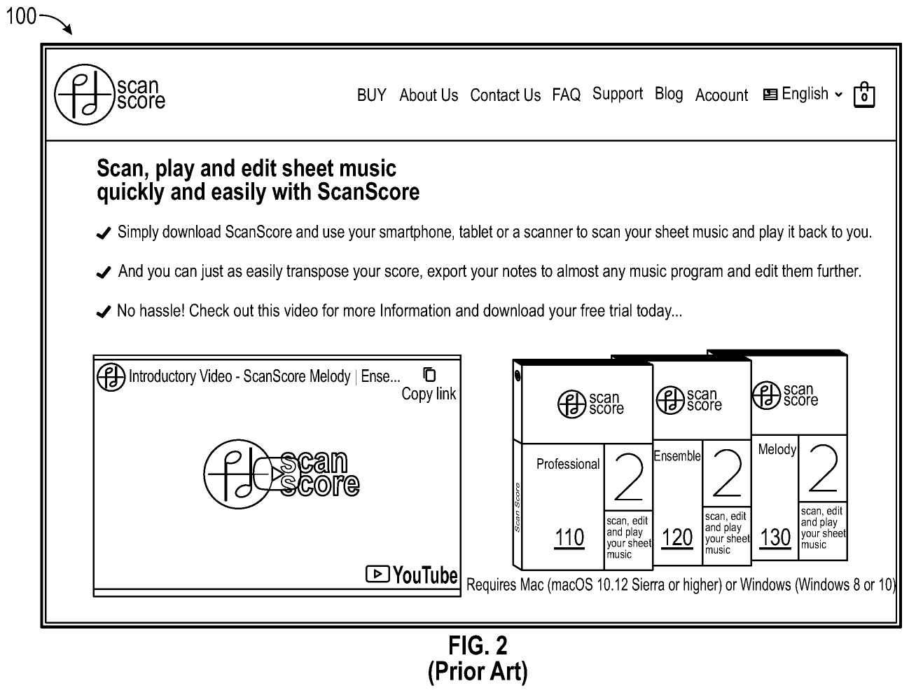

Referring to FIG. 2, this is a commercially available Prior Art product and its use here is for illustrative purposes only. The prior art of Scan Score 100 reads music and plays the music back, but is devoid of means or methods analyzing music played by others. The prior art may include a professional package 110 that self scans and plays music, which does little or nothing to proactively teach a person to play an instrument or to sing. The prior art may include an ensemble 120 or melody 130 package to scan and/or edit or play predefined music, which again does not help an aspiring musician or singer.

Referring to FIG. 3, a page of sheet music is shown to illustrate markings to help a student evaluate their performance. Within the disclosed embodiments, means and methods are presented to assist in helping a student play an instrument or sing. The output 200 may comprise the display of notes played or sung by a student in comparison to the notes of the music. The notes displayed may be shown in various colors to let an aspiring musician or singer know that a note has been played too loud, too soft, too fast, too slow, flat or sharp. In the black and white embodiment shown in FIG. 3, symbols are used to show loud 260, soft 265, fast 270, slow 275, flat 280 and sharp 285. The display of FIG. 3 overcomes shortfalls in the related art as music students are given both real time feedback on performance and are given a savable file that can be printed or viewed at any time. The readout of FIG. 3 allows both students and teachers to keep track of progress and areas needing work or further instruction.

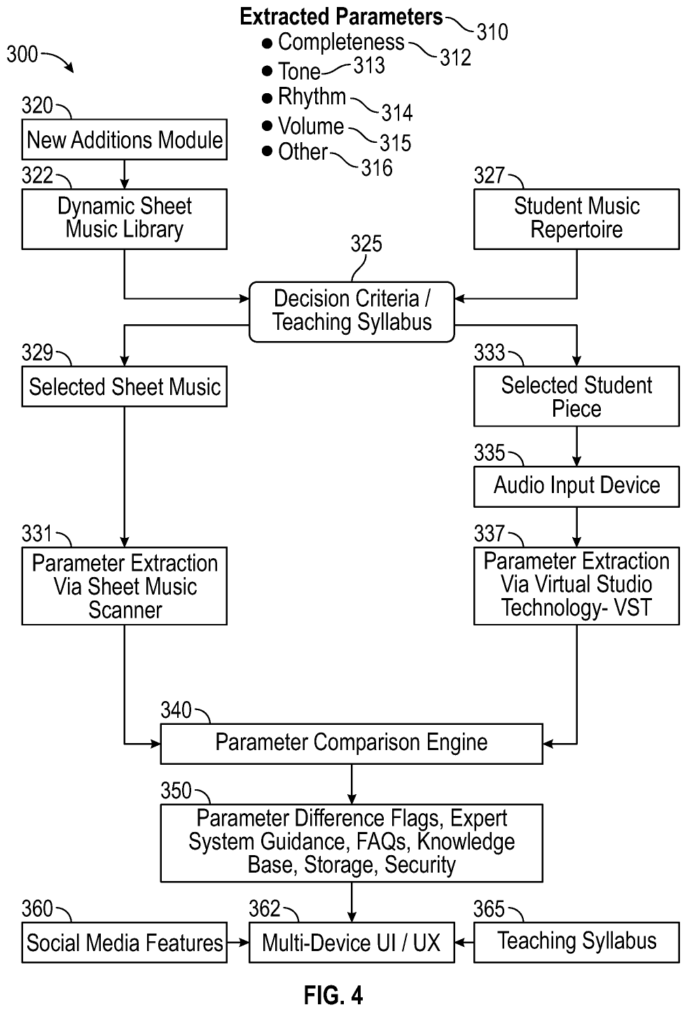

Referring to FIG. 4, a block diagram 300 presents both a flow chart and disclosure of embodiments in the form of computer components and/or nonvolatile memory and/or computer and/or database structures to produce the tangible output of FIG. 3 and/or to perform further functions and produce further outputs as described herein.

The disclosed embodiments may be used to produce tangle evidence of extracted parameters 310 wherein such extracted parameters may include metrics of a students performance defined by completeness 312, tone 313, rhythm 314, volume 315 or other 316 measurements.

Disclosed embodiments may comprise a tangible computer system 300 comprising a new additions module 320 that may receive sheet music or a non-transitory computer readable memory module containing musical annotations to reflect sheet music to be played or sung. The new additions module 320 may transfer music files into a dynamic sheet music library 322 which may comprise a database of entered music, the database accepting input from a decision criteria/teaching syllabus module 325.

The decision criteria teaching syllabus module 325 may send a command or otherwise transmit selected sheet music 329, which may have been stored and/or selected from the dynamic sheet music library 322. The selected sheet music may be sent to a parameter extraction module 331 that may include a sheet music scanner. The extracted parameters from the sheet music may be sent to a parameter comparison engine 340 to be compared with the playing or singing by a student. The parameter comparison engine 340 may then send output to a parameter difference module 350 which may produce an output of differences between the written and played music as shown in FIG. 3.

The parameter difference module 350 may comprise the output of parameter difference flags or indicia of differences such as loud 260 and soft 265 and other parameters. Such flags or indica may take the form of musical notes shown in different colors or drawn in different patterns.

The parameter difference module 350 may further comprise expert system guidance, frequently asked questions with answers, a knowledge base, storage capacity upon non-transitory computer readable memory and security systems.

The parameter difference module 350 may send output to a multi-device user interface system 362. The multi-device user interface system 362 may accept input from a social media module 360 and/or a teaching syllabus module 365.

The decision criteria teaching syllabus 325 may also direct a music file in response to a piece of music 333 selected by a student. The student may play an instrument or sing to the music with such sound entering an audio input device 335. The audio input may then be entered into a parameter extraction module 340 wherein the student's music output is converted or extracted into parameters such as completeness, tone, pitch, rhythm and volume with the extracted parameters sent to the parameter comparison engine 340 form comparison to the parameters extracted from the sheet music 331.

The disclosed embodiments include means and methods of producing weighted scores and analysis of a user's musical performance. For example, different weights or values may be assigned to each measured parameter to produce a weighted or overall performance score. Students and teachers alike will be interested in seeing the scores of performances recorded in the past by well known musicians. Musical recordings go back to the late nineteenth century. The disclosed embodiments may produce letter grades or scores. The disclosed embodiments may include means and methods for students to review the progress of fellow students which may be helpful in students selecting teachers. A weighted average module may accept input of weights to assign to each measured parameter and then produce a numeral score or letter grade.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

What is claimed is:

1. A system (300) for producing comparison of the execution of sheet music and the contents of the sheet music, so as to assist a student in producing musical sounds, the system comprising:
a) a new additions module (320) containing sheet music, the sheet music in the form of a non-transitory computer readable medium, comprising a sheet music file,
b) a dynamic sheet music module (322) receiving the sheet music file from the new additions module, the dynamic sheet music module in electronic connection to a decision criteria/teaching syllabus module (325);
c) the decision criteria/teaching syllabus module transmitting a selected sheet music file (329) to a parameter extraction module (331), the parameter extraction module extracting parameters from selected sheet music file;
d) a student music repertoire module (327) storing a database of student music; the student music repertoire module in electronic communication the decision criteria/teaching syllabus module;
e) the decision criteria/teaching syllabus module transmitting a selected piece of student music (333) for performance by a music student, with the performance entering an audio input device (335) for transmission to an parameter extraction module for played music (337);
f) the parameter extraction module for played music transmitting parameters to the parameter comparison engine to produce visual comparison of the parameters extracted.

2. The system of claim 1 wherein the comparison parameters extracted are displayed and include parameters of tone, rhythm and volume.

3. The system of claim 2 wherein the comparison of parameters extracted are displayed and further include pitch and speed.

4. The system of claim 1 further including a weighted average module accepting input of weights to assign to each measured parameter and the weighted average module producing a weighted score or letter grade.
